(19) United States
(12) Patent Application Publication
(10) Pub. No.: US 2024/0192577 A1
(43) Pub. Date: Jun. 13, 2024

(54) PHOTOSENSITIVE MODULE, CAMERA MODULE AND GIMBAL CAMERA APPARATUS

(71) Applicant: Jun JIANG, Shenzhen (CN)

(72) Inventors: Jun JIANG, Shenzhen (CN); Xuezhu WANG, Shenzhen (CN)

(21) Appl. No.: 18/533,862

(22) Filed: Dec. 8, 2023

(30) Foreign Application Priority Data
Dec. 13, 2022 (CN) 202211617727.5

(51) Int. Cl. G03B 17/56

(52) U.S. Cl. CPC G03B 17/561

(57) ABSTRACT

The present disclosure relates to an improved photosensitive module, a camera module and a gimbal camera apparatus. The photosensitive module includes: a shell, an image sensing assembly and a servo driver, where the servo driver drives the image sensing assembly, so that a photosensitive element rotates relative to the shell to achieve photosensitive effects at different angles. The load of the servo driver of the photosensitive module of the present disclosure is only an image sensor and necessary auxiliary circuits. Compared with a load in the traditional scheme, the load difference is generally one to several orders of magnitude.

### CROSS-REFERENCE TO RELATED APPLICATION

The present application claims priority to Chinese Patent Application No. 202211617727.5, filed on Dec. 13, 2022, titled “PHOTOSENSITIVE MODULE, CAMERA MODULE AND GIMBAL CAMERA APPARATUS”, the entire contents of which are incorporated herein by reference.

### TECHNICAL FIELD

The present disclosure relates to the field of motion shooting devices, and in particular to a photosensitive module, a camera module and a gimbal camera apparatus.

### BACKGROUND

In an existing gimbal technology, the design of the degree of freedom of normal rotation of a photosensitive element is realized by using a motor to drive a whole assembly (hereinafter referred to as a traditional lens sensor assembly) composed of a lens, a photosensitive element and a subsequent processing circuit. That is, in the working process of the gimbal, the relative position of the lens and the photosensitive element remains unchanged, the lens, the photosensitive element and an auxiliary part such as a signal processing circuit form a whole body, and the motor drives the whole body to realize the above requirement. This scheme has two disadvantages:

1) the traditional scheme requires a first-stage servo motor to drive the whole assembly at the lens and the sensor end, and a system with traditional scheme requires high servo driving ability. The weight of the lens assembly is often hundreds or even thousands of times or even more than that of the sensor. Therefore, driving the traditional lens sensor assembly also requires a large driving torque, thereby requiring a large motor. Therefore, this part is often large and heavy and has high cost.

2) For the sake of reducing the load of the next stage of driving motor and facilitating operation, the axis of the next stage of rotational degree of freedom is often designed to pass through the center of gravity of the traditional lens sensor assembly. Therefore, long mechanical construction is required to connect the driving motor of the traditional lens sensor assembly with the next stage of driving motor. In this way, the total size and weight of the gimbal are increased, the overall rigidity of the gimbal is reduced, and the imaging effect is not facilitated. This point is especially prominent in a case that the lens group is long, so the gimbal with an ultralong lens is rarely seen in the market. In addition, a larger external connection mechanism also affects the portability of the system and the potential integration design ability with a carrier.

The gimbal can be regarded as a cascade servo system composed of a plurality of motion pairs. Since the traditional lens sensor assembly is often in the final-stage of a gimbal cascade relationship, the mass of this stage has exponential significance in the overall mass of the system. It is of great significance to try to reduce the weight of this stage of driving motor to reduce the total weight of the gimbal system.

### SUMMARY

To overcome the shortcomings in the prior art, the present disclosure provides a photosensitive module with a photosensitive element capable of rotating relative to a mechanical supporting piece, a camera module, and a gimbal camera apparatus. According to the present application, the above module, device and apparatus are much more compact in structure and reasonable in layout, and the gimbal camera apparatus with a large-size lens which is difficult to achieve in the traditional gimbal configuration can be achieved.

A first aspect of the present disclosure provides a photosensitive module, including:

a shell;

an image sensing assembly, including a photosensitive element; and

a servo driver, including a stator connected to the shell, and a rotor rotating relative to the stator, the rotor being connected to the image sensing assembly,

where the servo driver drives the image sensing assembly, so that the photosensitive element rotates relative to the shell to achieve photosensitive effects at different angles.

A second aspect of the present disclosure provides a camera module, including:

a photosensitive module, the photosensitive module including:

a shell, and

an image sensing assembly, arranged in the shell and including a circuit board and a photosensitive element arranged on the circuit board and electrically connected to the circuit board; and

a servo driver, including a stator connected to the shell, and a rotor rotating relative to the stator, the rotor being connected to the image sensing assembly,

where the servo driver drives the image sensing assembly, so that the photosensitive element rotates relative to the shell to achieve photosensitive effects at different angles; and

a lens assembly, connected to the photosensitive module.

A third aspect of the present disclosure provides a gimbal camera apparatus, including: a camera device, comprising:

a photosensitive module, the photosensitive module comprising:

a shell, and

an image sensing assembly, arranged in the shell and including a circuit board and a photosensitive element arranged on the circuit board and electrically connected to the circuit board; and

a servo driver, including a stator connected to the shell, and a rotor rotating relative to the stator, the rotor being connected to the image sensing assembly,

where the servo driver drives the image sensing assembly, so that the photosensitive element rotates relative to the shell to achieve photosensitive effects at different angles.

The camera device further includes a lens assembly connected to the photosensitive module.

The gimbal camera apparatus further includes at least one connecting rod, wherein a driving assembly is arranged on each connecting rod, thereby achieving the rotating connection between the connecting rod and the camera device, or/and the rotating connection between connecting rods.

Compared with the prior art, the present disclosure has the following advantages:

1. The weight is light. The load of the servo driver of the photosensitive module of the present disclosure is only an image sensor and necessary auxiliary circuits. Compared with the traditional scheme in which the load is the whole lens and the sensor module, the load difference is generally one to several orders of magnitude, so that the requirement on the servo driver is greatly reduced, and the weight of the servo driver is greatly reduced. In addition, the load is at the last stage of a gimbal cascade relationship, and has exponential significance in the overall weight of the gimbal. Furthermore, the photosensitive module adopting this scheme will optimize the gimbal structure, thereby further reducing the weight of the system.

2. The structure is simple and easy to fold and store. Firstly, the photosensitive module of this scheme is provided with a built-in miniature rotating shaft which has a more compact structure compared with a first shaft of the traditional gimbal. In addition, compared with a three-axis gimbal, the total configuration of the system in this scheme is in the form of a U-shaped connection piece and an I-shaped lens assembly. When storage is required, the I shape is placed in the middle of the U shape, and the overall structure is very compact.

3. The gimbal structure is reasonable in stress. Compared with the three-axis gimbal, the first connecting rod is arranged vertically and is not required to be made into a cantilever beam configuration like the traditional scheme. In particular, in a case that the fixed end is above, the first connecting rod is subjected to a tensile force and the stress is most reasonable. Therefore, compared with the traditional scheme, the structure can be made very light, and sufficient structural strength and rigidity can be ensured.

4. The long-lens gimbal that cannot be achieved in the traditional method can be achieved easily. Since the second-stage and third-stage connecting rods of the traditional three-axis gimbal are required to bear the load of the lens camera assembly in the form of the cantilever, and the form of the cantilever requires the related structure to have large rigidity and strength, so for the long-lens gimbal, the traditional configuration is difficult to achieve.

5. The motion sensor is less disturbed. In this scheme, the structural rigidity is large, so the sensor mounted at the last stage is less disturbed, and the system controllability is higher from the control perspective.

### BRIEF DESCRIPTION OF THE DRAWINGS

FIG. 1 is a schematic diagram of a photosensitive module according to the present application;

FIG. 2 is a first structural schematic diagram of a photosensitive module according to the present application;

FIG. 3 is a second structural schematic diagram of a photosensitive module according to the present application;

FIG. 4 is a structural schematic diagram of a camera module according to the present application;

FIG. 5 is a structural schematic diagram of a traditional gimbal;

FIG. 6 is a structural schematic diagram of a two-degree-of-freedom gimbal camera apparatus according to the present application; and

FIG. 7 is a structural schematic diagram of a three-degree-of-freedom gimbal camera apparatus according to the present application.

In the drawings: 101-lens assembly, 102-photosensitive element, 103-shooting object, 104-auxiliary mark, 105-optical axis, 2-photosensitive module, 201-shell, 202-servo driver, 203-stator, 204-rotor, 205-circuit board, 206-photosensitive element, 207-electrical connection piece, 208-connection piece, 209-wire, 210-annular light-insulating piece, 211-stator, 212-rotor, 213-bearing, 3-camera module, 301-lens assembly, 4-electronic device, 5-gimbal, 501-camera device, 502-first connecting rod, 503-second connecting rod, 504-servo driver, 6-gimbal camera device, 601-first connecting rod, 602-first servo motor, 603-second connecting rod, 604-second servo motor.

### DETAILED DESCRIPTION OF THE EMBODIMENTS

The present disclosure is further explained below with reference to specific embodiments, but it is not limited to the present disclosure. The structure, scale, size, etc. shown in the drawings of the specification are only used to cooperatively describe the content disclosed by the specification for those skilled in the art to understand and read, and are not intended to limit the implementation of the present disclosure. Therefore, it has no technical substantive significance. Any structural modification, change of a scale relationship or adjustment of size should still fall within the scope which can be covered by the technical content disclosed by the present disclosure without affecting the effects and the objective achieved by the present disclosure. Meanwhile, the terms such “upper”, “lower”, “front”, “rear”, “middle” quoted in this specification are only convenient for a clear description and are not used to limit the implementable scope of the present disclosure. The change or adjustment of the relative relationship should be regarded as the implementable scope of the present disclosure without substantial change of the technical content.

The present application is characterized in that a photosensitive element or a photosensitive element assembly can rotate independently around a lens axis relative to a bearing part thereof. In a case that the bearing part does not rotate, the imaging effect that can be achieved through the overall rotation of the traditional camera device around the lens axis can be achieved.

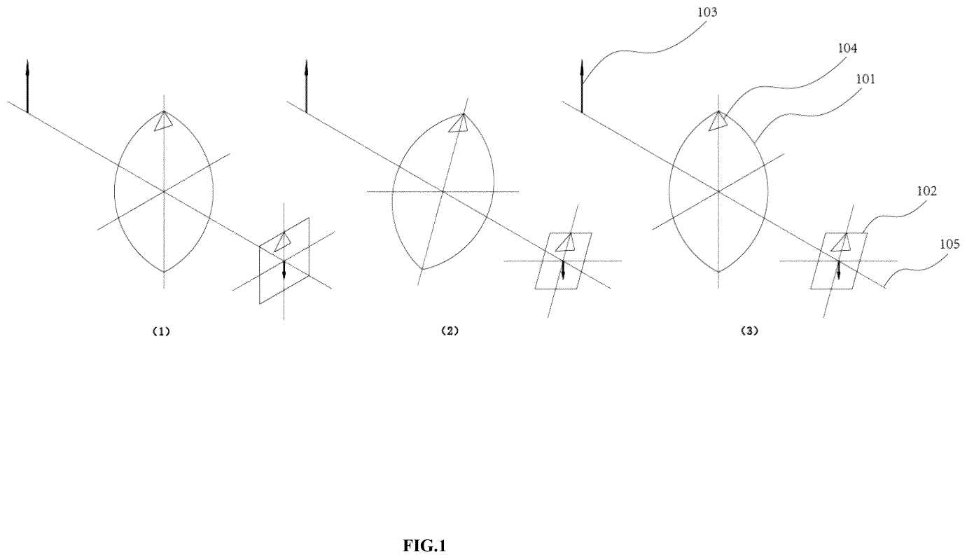

For example, referring to FIG. 1, FIG. 1(1) is an initial state when the axis imaging rotation at a certain angle is required. The prior art is shown in FIG. 1(2), it is necessary to drive a lens assembly 101 and a photosensitive element 102, that is, the imaging effect that can be achieved through the overall rotation of the traditional camera device. The technical solution of the present application is: as shown in FIG. 1(3), the posture of the lens assembly 101 is kept unchanged, and it is only necessary to drive the photosensitive element 102 or the photosensitive element 102 and the auxiliary electromechanical parts thereof to rotate. Generally, a lens in the lens assembly 101 has a centrosymmetric structure. Therefore, in this process, in a case that the lens assembly 101 moves around the axis, the imaging is not affected. The weight of the actual rotation part of the present application is far less than the overall weight of the camera device, so compared with the traditional scheme, driving can be achieved by a miniature motor.

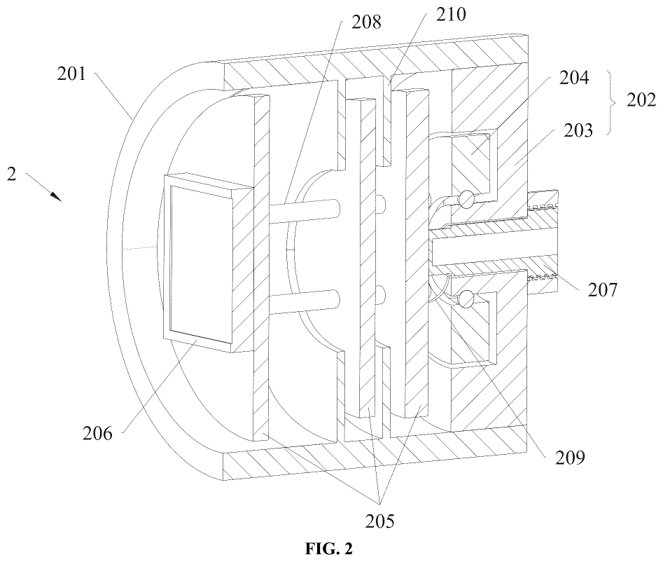

Specifically, in Embodiment 1, as shown in FIG. 2, a photosensitive module 2 according to the present application includes:

a shell 201, a photosensitive channel being formed in the shell 201;

a servo driver 202, a stator 203 of the servo driver being arranged on one side of the photosensitive channel and being fixedly connected to an inner wall of the photosensitive channel, and a rotating shaft of a rotor 204 of the servo driver coinciding with an optical axis of the photosensitive axis; and

an image sensing assembly, including a circuit board 205 and a photosensitive element 206 arranged on the circuit board 205. According to design scheme, the circuit board 205 may be designed as one piece, or may adopt a circuit assembly composed of a plurality of circuit boards, where the plurality of circuit boards electrically communicate with one another through electrical connection pieces.

The rotor 204 of the servo driver 202 is connected to an image sensing assembly. When the rotor 204 rotates, the image sensing assembly rotates relative to the shell 201 accordingly. A rotating axis of the servo driver 202 is perpendicular to the plane of the photosensitive element 206 and passes through the center of the effective photosensitive range (usually a rectangle) of the photosensitive element 206. A photosensitive surface of the photosensitive element 206 is back to the servo driver 202. When being driven by the servo driver 202 to rotate, the photosensitive element 206 is angularly offset relative to the mechanical supporting piece, thereby achieving the photosensitive effects at different angles. The offset angle may be not limited, or may rotate continuously according to an expected rotating direction. In this embodiment, the circuit board 205 is composed of a plurality of circuit boards, and the circuit boards 205 are connected through connection pieces 208, thereby achieving the synchronous motion of the plurality of circuit boards 205. The servo driver 202 is provided with a through hole along the axis, and the through hole is a physical channel of an electrical connection piece 207. An electronic device and a circuit in the shell 201 are in electric energy or/and communication connection with the outside through the electrical connection piece 207. In this embodiment, an electric slip ring is arranged in the through hole to serve as the electrical connection piece 207 to provide mechanical support. A wire 209 of the circuit board 205 is connected to an inner ring of the electric slip ring of the rotor 204 of the servo driver, and the image sensing assembly is electrically connected to an external device through the electric slip ring.

In this embodiment, the circuit board 205 of the image sensing assembly serves as a light-insulating piece, the circuit board 205 adopts circular design, and the plurality of circuit boards 205 are distributed in parallel. The circuit board 205 is in fit with an annular light-insulating piece 210 on an inner wall of the shell 201 to form a light-insulating structure with a cross section in a serpentine corridor form, thereby playing a light-insulating role. In addition, in some embodiments, the light-insulating piece may be achieved by a special mechanical structure. For example, a ring is arranged on the shell 201, and a disk is arranged on a rotating assembly correspondingly. An optical path is blocked between the ring and the disk, which is a circuitous path, such as a serpentine path, seen from the cross section. The light-insulating piece may be designed in other constitution units in a fused manner. For example, the servo driver 202 is designed as a motor with a light-insulating function.

In some embodiments, a sensor assembly is arranged on the photosensitive module 2, and includes a motion sensor or/and an angle sensor.

The motion sensor is arranged on the circuit board 205 to which the photosensitive element is attached, or is arranged on other structures which rotate coaxially with the photosensitive element, thereby sensing the motion state of the photosensitive element in real time. The motion sensor includes one or a combination of a gyroscope, an accelerometer, an electromagnetic compass and GPS.

The angle sensor is configured to measure the relative angular motion between the photosensitive element and the shell 201. The angle sensor is arranged on a rotating pair. Two parts which move relatively are fixedly connected to the shell 201 and a rotating part, respectively. The angle sensor includes one or a combination of an encoder, a potentiometer and a rotary transformer.

In some embodiments, a controller is arranged on the photosensitive module 2 and is configured to control the servo driver 202 to drive the photosensitive element 206 to rotate to an expected position. The controller acquires information of the sensor assembly, and controls the servo driver 202 according to an expected rotating angle of the photosensitive element 206, so that the image sensing assembly arrives at the angle. In addition, when necessary, the controller may obtain the motion state according to a state solution method, rather than the sensor reading represented by the sensor assembly. For example, posture information solved by the original information of the sensor serves as a control basis. The controller controls the servo driver 202 according to a control law. In the motion process of driving the image sensing assembly to arrive at the angle, the specified motion state trajectory or the specified dynamic characteristic is met. For example, the controller controls the motor according to the control law to inhibit the motion at some frequencies, so that the sensor can obtain the required image clearness. The function of the controller further includes: coordinating the operation of each module in the system and performing task scheduling and other works.

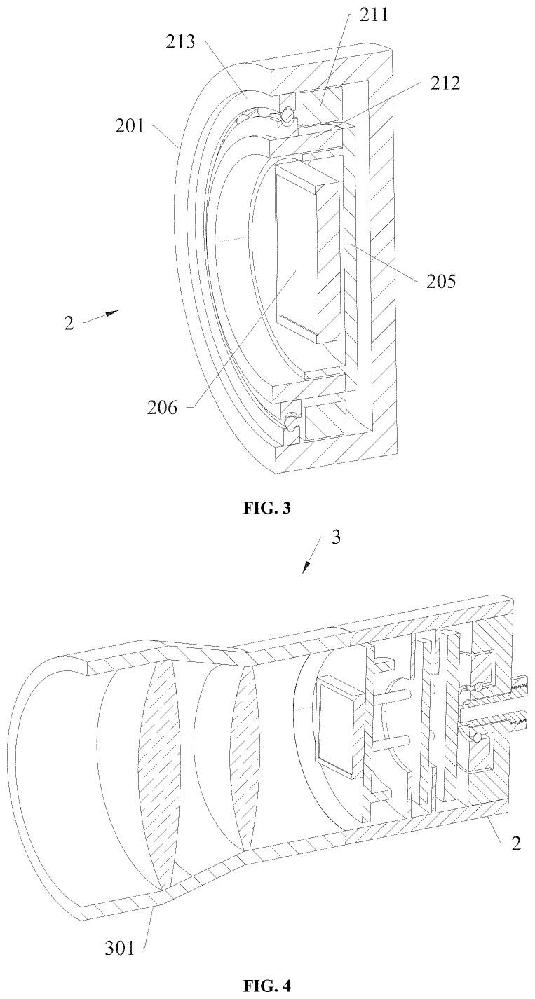

In Embodiment 2, based on Embodiment 1, the embodiment of the present application provides another photosensitive module 2, as shown in FIG. 3, which is different from Embodiment 1 in that:

To make the structure more compact, the rotor 212 of the servo driver 202 adopts a ring structure, one end of the rotor 212 is fixedly connected to an inner wall of the shell 201 through a bearing 213, the other end of the rotor is embedded into the stator 211 and is in clearance fit with an inner wall of the stator 211, and the stator 211 is fixedly connected to the inner wall of the shell 201. The circuit board 205 of the image sensing assembly is fixedly connected to the rotor 212. In this embodiment, the ring structure of the rotor 212 provides a photosensitive channel for the photosensitive element 206. In this embodiment, the circuit board 205 is designed as one piece shown in the figure, or certainly may be designed as a plurality of pieces shown in Embodiment 1.

In this embodiment, the electrical connection piece is implemented in a wireless manner. Specifically, the circuit board 205 of the image sensing assembly is provided with a wireless power supply receiving end. To improve the stability, the wireless power supply receiving end is arranged at the center of the circuit board 205. Correspondingly, a bottom plate corresponding to the circuit board 205 of the image sensing assembly is arranged on the shell 201, and the bottom plate is provided with a wireless power supply transmitting end. In this embodiment, communication is performed wirelessly. That is, one end of wireless communication is arranged on a supporting circuit of the image sensing assembly, and the other end of wireless communication is arranged outside the shell 201, so that an internal and external communication function is achieved.

In Embodiment 3, the present application provides a camera module 3. As shown in FIG. 4, the camera module includes the photosensitive module 2 of the present application, and further includes a lens assembly 301. The lens assembly 301 is an assembly with a “lens” function in the field of photography. The common function includes: adjusting an aperture, adjusting a focal length and the like. The lens assembly 301 is provided with a mechanical connection structure, and the photosensitive module 2 of the present application is provided with a connection structure in fit with the lens assembly 301, so that the two are connected stably, and the photosensitive element 206 in the photosensitive module 2 is located at a proper position to achieve a proper optical imaging effect. The lens assembly 301 is further provided with an electronic connection piece, the photosensitive module 2 is provided with an electrical connection joint in fit with the lens assembly 301, and the electrical connection of the two achieves the communication between the lens assembly 301 and the photosensitive module 2. The controller further includes functions of communicating with the outside and performing various tasks in addition to the functions mentioned in Embodiment 1. For example, in the application of the gimbal system, the controller of the camera module 3 may receive a control instruction sent by the gimbal, and drive the servo driver 202 according to the signal to control the image sensing assembly to a specified position. The controller may also receive a series of control instructions of other related units, and drive the image sensing assembly according to a specified parameter and a specified motion trajectory, so that the automatic camera shooting effect is achieved.

The camera module 3 is provided with a supporting circuit, and the function includes: providing a stable power supply, acquisition of an original signal of a photosensitive element, processing of an image signal, compression of the image signal, transmission of the image signal, data storage, communication and a conventional functional circuit. The functional composition of the supporting circuit is selected according to the actual design scheme. Part of functions may be selected according to the actual design scheme to be allocated in the photosensitive module 2. The specific implementation of the supporting circuit is a conventional technology, which is not elaborated herein.

The present application provides an electronic device 4, including the photosensitive module 2 or camera module 3. The electronic device may be but not limited to a camera, a video camera, a mobile phone, a tablet computer, a wearable device and the like.

As shown in FIG. 5, in the traditional gimbal, since a pitch axis is generally required to pass through the center of mass of the camera device 501, a first connecting rod 502 and a second connecting rod 503 of the gimbal require a larger size. The size is generally more than half of the length of the camera module. In a case that the size of the camera module is excessively large, the sizes of the first connecting rod 502 and the second connecting rod 503 are very large according to the traditional design scheme. Since the first connecting rod 502 and the second connecting rod 503 are of cantilever beam structures, it is difficult to design a gimbal system with sufficient strength while ensuring that the system is light enough. Or the overall weight is huge and unpractical on the premise of ensuring the rigidity of the system. In addition, the requirement on the driving ability of the servo driver 504 is high, so that the cost is high and the overall cost is difficult to control. The present application provides a gimbal device, including the camera module of the present application. The camera module of the present application has a particularly outstanding advantage of applying one rotational degree of freedom to the gimbal, thereby effectively solving the above technical problem.

The present application provides a gimbal camera device 6, including the camera module 3 or the electronic device 4, and driving assemblies arranged on connecting rods. The camera device 3 or the electronic device 4 is rotatably connected to the connecting rods through the driving assemblies. Each of the driving assemblies includes a servo motor and a supporting structure. In some embodiments, the electronic device 4 or the camera device 3 are connected, through an adapter, to a driving assembly for driving the motion of the electronic device or the camera module. The adapter may be designed adaptively, and can be better connected to a device thereon. The driving assembly is provided with a universal interface, and the adapter is provided with a corresponding interface in fit with the universal interface. A plurality of connecting rods may be provided according to requirements, and the connecting rods are rotatably connected through the driving assemblies. In some embodiments, the controller may be arranged in the photosensitive module 2 or/and the camera module 3 or/and the electronic device 4, or/and be arranged on the connecting rod 601 or/and arranged at other proper positions. A plurality of controllers may be provided, and the plurality of controllers are reasonably distributed and arranged and work cooperatively. The specific implementation is a conventional technology, which is not elaborated herein.

The present application performs description by taking a two-degree-of-freedom gimbal and a three-degree-of-freedom gimbal as examples of the gimbal camera device 6.

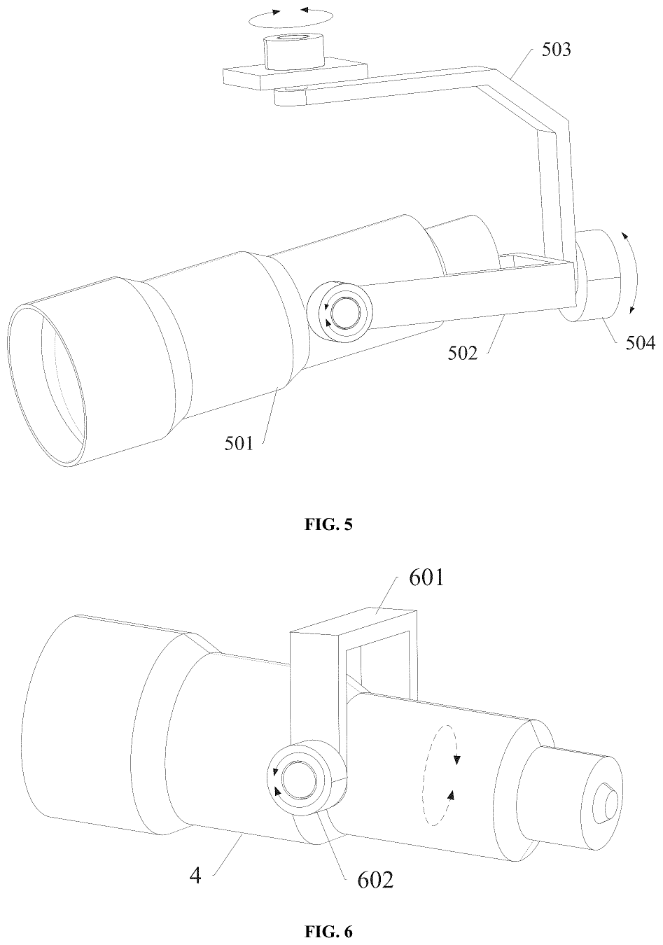

In Embodiment 4, as shown in FIG. 6, a two-degree-of-freedom gimbal includes the electronic device 4 (the camera device 3) and the first connecting rod 601 of the present application. The first connecting rod 601 is connected to the electronic device 4 (the camera device 3) through a first servo motor 602 and a rotating pair. In this embodiment, an axis of the lens of the camera module does not coincide with an axis of the first servo motor 602, and the degree of freedom of the rotating pair and one rotational degree of freedom in the camera module form two degrees of freedom. For most applications, the axis of the lens of the camera module and the axis of the first servo motor 602 are perpendicular to each other. In this embodiment, the first connecting rod 601 adopts a U-shaped structure, and the axis of the first servo motor 602 and the axis of the lens of the camera module are perpendicular to each other. With this structure, the first servo motor 602 drives the electronic device 4 (the camera device 3) to generate pitching motion or heading motion, and the rotation of the photosensitive element in the electronic device 4 (the camera device 3) is equivalent to rolling motion. In some embodiments, the first connecting rod 601 is fixedly connected to a base.

In some embodiments, the first connecting rod 601 is provided with a first angular motion sensor which is configured to measure the angular motion between the first connecting rod and the electronic device 4 (the camera device 3) and includes at least one of a potentiometer, an encoder and a rotary transformer. The first angular motion sensor is electrically connected to the controller.

In some embodiments, a first motion sensor may be arranged on the first connecting rod 601 and the electronic device 4 (the camera device 3), and more state information can be further acquired according to the first motion sensor to better control the motion of the system. For example, the angular velocity difference or the relative posture between the motion sensor and the first motion sensor is controlled according to the motion sensor in the electronic device 4 (the camera device 3) and the first motion sensor on the first connecting rod 601. The first motion sensor is electrically connected to the controller.

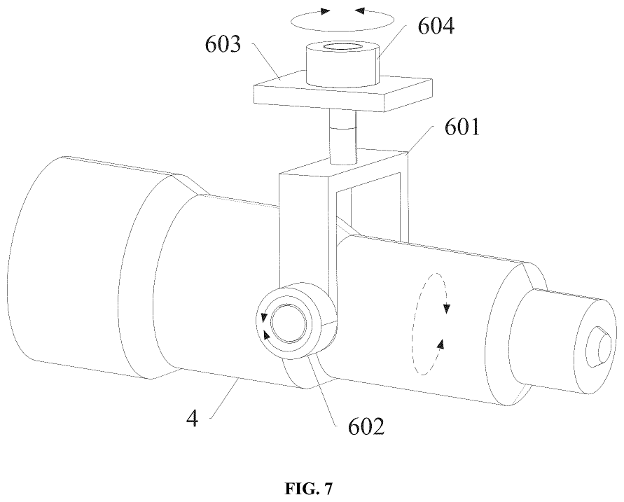

In Embodiment 5, as shown in FIG. 7, a three-degree-of-freedom gimbal adds another degree-of-freedom motion based on the two-degree-of-freedom gimbal. Here, the first connecting rod 601 still adopts U-shaped design, and the connection manner of the first connecting rod 601 and the electronic device 4 (the camera device 3) is the same as that in the above embodiment. A second connecting rod 603 is added to the bottom of the U-shaped structure of the first connecting rod 601, and the second connecting rod 603 is rotatably connected to the first connecting rod 601 through a second servo motor 604. An axis of the second connecting rod 603 is the same as an axis of the second servo motor 604, and is mutually perpendicular to the axis of the first servo motor 602. The second servo motor 604 drives the electronic device 4 (the camera device 3) to generate heading motion or pitching motion. In some embodiments, the second connecting rod 603 is fixedly connected to a base.

In some embodiments, the second connecting rod 603 is provided with a second angular motion sensor which is configured to measure the angular motion between the first connecting rod 601 and the second connecting rod 603 and includes at least one of a potentiometer, an encoder and a rotary transformer. The second angular motion sensor is electrically connected to the controller.

In some embodiments, a second motion sensor may be arranged on the second connecting rod 603, and more state information can be further acquired according to the second motion sensor to better control the motion of the system. For example, the angular velocity differences or the relative postures between the second connecting rod 603 and the first connecting rod 601 and between the electronic device 4 (the camera device 3) and the first connecting rod are controlled, respectively. The second motion sensor is electrically to the controller.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

What is claimed is:

1. A photosensitive module, comprising:
a shell;
an image sensing assembly, comprising a photosensitive element; and
a servo driver, comprising a stator connected to the shell, and a rotor rotating relative to the stator, the rotor being connected to the image sensing assembly,
wherein the servo driver drives the image sensing assembly, so that the photosensitive element rotates relative to the shell to achieve photosensitive effects at different angles.

2. The photosensitive module according to claim 1,
wherein the image sensing assembly further comprises at least one circuit board.

3. The photosensitive module according to claim 2,
wherein the photosensitive element is arranged on one of the at least one circuit board.

4. The photosensitive module according to claim 2,
wherein the photosensitive element is electrically connected to the at least one circuit board.

5. The photosensitive module according to claim 1,
wherein a rotating axis of the servo driver is perpendicular to a plane of the photosensitive element.

6. The photosensitive module according to claim 5,
wherein the rotating axis of the servo driver passes through the center of an effectively sensing range of the photosensitive element, so that the rotating axis and the center of the photosensitive element are located at a same optical axis.

7. The photosensitive module according to claim 1,
wherein a sensor assembly is arranged on the photosensitive module and comprises a motion sensor or/and an angle sensor, and the sensor assembly is configured to acquire a rotating state of the photosensitive element.

8. The photosensitive module according to claim 1,
wherein a controller is arranged on the photosensitive module, and the controller is configured to control the servo driver to drive the photosensitive element to rotate to an expected position.

9. The photosensitive module according to claim 1,
wherein an electrical connection piece is arranged on the photosensitive module, and an electronic device and a circuit in the shell are in electric energy or/and communication connection with the outside of the shell through the electrical connection piece.

10. The photosensitive module according to claim 9,
wherein the electrical connection piece comprises an electric slip ring, or an electrical connector for realizing electric energy and communication transmission in a wireless manner.

11. The photosensitive module according to claim 2,
wherein an annular light-insulating piece is arranged on an inner wall of the shell, and the annular light-insulating piece is in fit with the circuit board and/or the photosensitive element to form a light-insulating structure.

12. The photosensitive module according to claim 1,
wherein the servo driver comprises:
the stator with an annular structure, an outer wall of the stator being fixedly connected to an inner wall of the shell; and
the rotor with an annular structure, one end of the rotor being embedded into the stator and being in clearance fit with an inner wall of the stator, and the other end of the rotor being connected to the inner wall of the shell through a bearing.

13. A camera module, comprising:
a photosensitive module, the photosensitive module comprising:
a shell, and
an image sensing assembly, comprising a photosensitive element, and
a servo driver, comprising a stator connected to the shell, and a rotor rotating relative to the stator, the rotor being connected to the image sensing assembly,
wherein the servo driver drives the image sensing assembly, so that the photosensitive element rotates relative to the shell to achieve photosensitive effects at different angles; and
a lens assembly, connected to the photosensitive module.

14. A gimbal camera apparatus, comprising:
a camera device, comprising:
a photosensitive module, the photosensitive module comprising:
a shell, and
an image sensing assembly, comprising a photosensitive element, and
a servo driver, comprising a stator connected to the shell, and a rotor rotating relative to the stator, the rotor being connected to the image sensing assembly,
wherein the servo driver drives the image sensing assembly, so that the photosensitive element rotates relative to the shell to achieve photosensitive effects at different angles;
the camera device further comprises a lens assembly connected to the photosensitive module; and
the gimbal camera apparatus further comprises at least one connecting rod, wherein a driving assembly is arranged on each connecting rod, thereby achieving the rotating connection between the connecting rod and the camera device, or/and the rotating connection between connecting rods.

15. The gimbal camera apparatus according to claim 14,
wherein the camera module is connected directly to or connected, through an adapter, to the driving assembly for driving the motion of the camera module.

16. The gimbal camera apparatus according to claim 14,
wherein an angular motion sensor and/or a motion sensor are arranged on the connecting rod.
